(19) United States
(12) Patent Application Publication
(10) Pub. No.: US 2014/0249274 A1
(43) Pub. Date: Sep. 4, 2014

(54) HIGH FUNCTIONALITY ISOCYANATES AS POLYMER POLYOL STABILIZERS AND THE POLYMER POLYOLS PREPARED FROM THESE STABILIZERS

(71) Applicant: BAYER MATERIALSCIENCE LLC, Pittsburgh, PA (US)

(72) Inventor: Rick L. Adkins, Canonsburg, PA (US)

(73) Assignee: Bayer MaterialScience LLC, Pittsburgh, PA (US)

(21) Appl. No.: 13/783,459

(22) Filed: Mar. 4, 2013

(51) Int. Cl. C08F 226/02; C08G 18/83

(52) U.S. Cl. CPC C08F 226/02; C08G 18/831
USPC 525/123; 526/301; 525/260; 560/205

(57) ABSTRACT

A high functionality macromer that is the reaction product of (1) a polyisocyanate having an NCO group content of about from about 10% to about 33% having a functionality greater than 2, (2) at least one alcohol with reactive unsaturation, and (3) a hydroxyl group-containing polyether having an OH number of from 9 to 60 and a functionality of from 1 to 6 is used to produce a pre-formed stabilizer that is used to produce a high solids content polymer polyol.

### BACKGROUND OF THE INVENTION

This invention relates to ethylenically unsaturated macromers prepared from high functionality isocyanates which contain reactive unsaturation, pre-formed stabilizers prepared from these macromers, polymer polyols prepared from the macromers and the pre-formed stabilizers, and processes for the preparation of these compositions.

Polymer polyols are composed of a dispersion of a polymer in a continuous phase that is usually a polyoxyalkylene polyol. Polymer polyols are particularly useful in the production of flexible polyurethane foams, particularly, high resilience, slabstock and molded foams. See, for example, U.S. Pat. Nos. 4,837,263 and 5,171,759.

Processes for the production of polymer polyols by polymerization of a monomer mixture in an organic polyol medium are known to those skilled in the art. One method for producing polymer polyols that has been found to be particularly advantageous is the use of pre-formed stabilizers. See, for example, U.S. Pat. No. 6,013,731.

A pre-formed stabilizer is defined as an intermediate obtained by reacting a macromer containing reactive unsaturation (e.g. acrylate, methacrylate, maleate, etc.) with monomers (e.g. acrylonitrile, styrene, methyl methacrylate, etc.), optionally in a diluent or a solvent (e.g. methanol, isopropanol, toluene, ethylbenzene, polyether polyols, etc.) to give a co-polymer (dispersion having e.g. a low solids content (e.g. <20%), or soluble grafts, etc.).

A pre-formed stabilizer (PFS) is particularly useful for preparing a polymer polyol having a lower viscosity at a high solids content. In the pre-formed stabilizer processes, a macromer is reacted with monomers to form a co-polymer composed of macromer and monomers. These co-polymers comprising a macromer and monomers are commonly referred to as pre-formed stabilizers (PFS). Reaction conditions may be controlled such that a portion of the co-polymer precipitates from solution to form a solid. In many applications, a dispersion having a low solids content (e.g., 3 to 15% by weight) is obtained. Preferably, the reaction conditions are controlled such that the particle size is small, thereby enabling the particles to function as “seeds” in the polymer polyol reaction.

Pre-formed stabilizers of U.S. Pat. No. 5,196,476 are prepared by polymerizing a macromer and one or more ethylenically unsaturated monomers in the presence of a free-radical polymerization initiator and a liquid diluent in which the pre-formed stabilizer is essentially insoluble. EP 0,786,480 discloses a process for the preparation of a pre-formed stabilizer by polymerizing, in the presence of a free-radical initiator, from 5 to 40% by weight of one or more ethylenically unsaturated monomers in the presence of a liquid polyol comprising at least 30% by weight (based on the total weight of the polyol) of a coupled polyol which may contain induced unsaturation. These pre-formed stabilizers can be used to prepare polymer polyols which are stable and have a narrow particle size distribution. The coupled polyol is necessary to achieve a small particle size in the pre-formed stabilizer, which preferably ranges from 0.1 to 0.7 micron. U.S. Pat. Nos. 6,013,731 and 5,990,185 also disclose pre-formed stabilizer compositions comprising the reaction product of a polyol, a macromer, at least one ethylenically unsaturated monomer, and a free radical polymerization initiator.

Large, bulky molecules are known to be effective macromers because less material can be used to sterically stabilize the particles. See, for example, EP 0786480. Generally, this is due to the fact that a highly branched polymer has a considerably larger excluded volume than a linear molecule (such as, e.g., a monol), and therefore less of the branched polymer is required. U.S. Pat. No. 5,196,476 discloses that functionalities of 2 and higher, and preferably 3 and higher, are suitable to prepare macromers. EP 0,162,589 and U.S. Pat. No. 5,990,185 describe a macromer, and polymer polyols prepared therefrom, wherein the macromer is prepared by transesterification of a vinyl alkoxysilane with a polyol. Coupling multi-functional polyols with polyisocyanates is also known and described in the field of polymer polyols as a suitable means to increase the molecular weight of the macromer. EP 0786480 discloses a process for preparation of a pre-formed stabilizer wherein the liquid polyol comprises at least 30% coupled polyol. As described therein, a high concentration of coupled polyol is useful for obtaining particles with a small particle size in the pre-formed stabilizer (PFS) and the induction of reactive unsaturation into a coupled polyol is a useful means for incorporating coupled polyol into the particles. U.S. Pat. No. 6,013,731 describes enhancing the stability of the dispersion by coupling high molecular weight polyols to form an even higher molecular weight product. Macromers prepared from polyols with low intrinsic unsaturation (<0.020 meq/gram) are also described therein. This patent further discloses that such polyols have a low concentration of oxyalkylated, allylic unsaturation-containing monols, and are therefore advantageous because the high concentration of monols present in conventional polyols lowers the average functionality of the polyol.

Macromers based on multi-functional polyols and which have multiple sites of reactive unsaturation are described in U.S. Pat. No. 5,196,476. As described therein, there is an upper limit to the concentration of unsaturation when making macromers by the maleic anhydride route. If the ratio of moles of unsaturation per mole of polyol is too high, then there is a higher probability that species will be formed which have more than one double bond per molecule. Typically, the '476 patent employs from about 0.5 to about 1.5 moles, and preferably from about 0.7 to about 1.1 moles, of the reactive unsaturated compound for each mole of the alkoxylated polyol adduct.

U.S. Pat. No. 5,854,386 discloses stabilizers for polymer polyols which contain both hydroxyl-functionality and unsaturation-functionality. These are prepared by oxyalkylating an unsaturated monomer having at least one oxyalkylatable hydrogen in the presence of an effective amount of a DMC catalyst, and optionally, in the presence of a free-radial polymerization inhibitor. These stabilizers preferably correspond to mixtures containing one or more of the two formulae: R[-R²—O—)ₙH]ₒ or R—(—X-{-(R²—O)ₙ—H}ₘ)ₒ wherein: o is an integer between 1 and 8; n is an integer whose average value is such that the product n.o is from 10 to 500; R² is alkylene or substituted alkylene; X is a linking group; and R is a C₂₋₃₀ hydrocarbon containing at least one site of ethylenic or ethylynic (acetylenic) unsaturation, optionally substituted by non-reactive groups and optionally containing interspersed heteroatoms. R may be aliphatic, cycloaliphatic, aromatic, arylaliphatic, or heteroaromatic with the proviso that when R is aromatic or heteroaromatic, the aromatic ring structure is substituted by at least one ethylenic or ethylynic radical-containing group.

There is a continuing need for novel macromers and novel preformed stabilizers to further advance the properties and characteristics of polymer polyols prepared from these macromers and preformed stabilizers. Although numerous macromers and preformed stabilizers are known, these have not previously been prepared from high functionality polyisocyanates.

### SUMMARY OF THE INVENTION

The present invention is directed to high functionality macromers which are the reaction products of (a) at least one polyisocyanate having an NCO group content of from about 10% to about 33% having a functionality greater than 2, (b) at least one alcohol with reactive unsaturation, and (c) at least one hydroxyl group-containing polyether having an OH number of from 9 to 60 and a functionality of 1 to 6, optionally, in the presence of (d) one or more urethane catalysts. In a preferred embodiment of the present invention, (a) and (b) are reacted to form a modified polyisocyanate and this modified polyisocyanate is then reacted with (c), optionally, in the presence of (d) a catalyst.

The present invention is also directed to preformed stabilizers which are the free-radical polymerization products of (A) at least one of the high functionality macromers of the present invention and (B) at least one ethylenically unsaturated monomer formed in the presence of (C) at least one free-radical polymerization initiator, and, optionally, (D) a liquid diluent, and, optionally, (E) a chain transfer agent.

The present invention is also directed to polymer polyols which are the reaction product of (I) a base polyol having a hydroxyl number of from about 20 to about 500 and a functionality of from about 2 to about 6 and an equivalent weight of from about 100 to about 3,000, and (II) at least one of the high functionality macromers of the present invention or at least one of the preformed stabilizers prepared from a high functionality macromer of the present invention, and (III) at least one ethylenically unsaturated monomer, formed in the presence of (IV) at least one free-radical polymerization initiator, and, optionally, (V) a chain transfer agent.

The present invention is also directed to processes for the preparation of the high functionality macromers, preformed stabilizers and polymer polyols of the present invention.

The present invention is also directed to foams prepared from the polymer polyols of the present invention and processes for making such foams.

### DETAILED DESCRIPTION OF THE INVENTION

The high functionality macromers of the present invention are the reaction products of (a) at least one polyisocyanate having an NCO group content of at least about 10% NCO, and preferably of at least about 15% NCO, and more preferably of at least about 20% NCO. These polyisocyanates are also typically characterized by an NCO group content of no more than 33% NCO, preferably less than or equal to about 32% NCO and more preferably less than or equal to about 31% NCO. These polyisocyanates may also have an NCO group content ranging between any combination of these upper and lower values, inclusive. For example, the polyisocyanates may have an NCO group content of from about 10% by weight NCO to about 33% by weight NCO, preferably from about 15% by weight NCO to about 32% by weight NCO and more preferably from about 20% by weight NCO to about 31% by weight NCO. The polyisocyanates suitable for use in the production of the macromers of the present invention generally have a functionality greater than 2, preferably from 2.1 to 4.1, most preferably, from 2.5 to 3.5.

In accordance with the present invention, suitable polyisocyanates useful as component (1) in the production of the high functionality macromers of the present invention include any of the known aliphatic and/or aromatic polyisocyanates having a functionality greater than 2.

Examples of suitable polyisocyanates include: aromatic polyisocyanates, aliphatic polyisocyanates, aromatic and aliphatic allophanates, trimers, dimer/trimer, biurets, and mixtures thereof.

Suitable alcohols with reactive unsaturation useful as component (b) in producing the macromers of the present invention include compounds which contain at least one, and preferably only one αβ-ethylenically unsaturated group and one hydroxyl group. Suitable compounds to be used as the ethylenically unsaturated alcohols include: hydroxyalkyl acrylates, hydroxyalkyl methacrylates, hydroxyalkoxy acrylates, hydroxyalkoxy methacrylates, hydroxyaryl acrylates, hydroxyaryl methacrylates, aromatically-substituted ethylenically unsaturated monols, isopropenyl-phenyl monols, and hydroxyl nitriles. Specific examples of such compounds include: 2-hydroxyethyl acrylate, 2-hydroxyethyl methacrylate, 2-hydroxypropyl acrylate, 2-hydroxypropyl methacrylate, 2-hydroxybutyl acrylate, 2-hydroxybutyl methacrylate, 2-hydroxypentyl acrylate, 2-hydroxypentyl methacrylate, 2-hydroxyhexyl acrylate, 2-hydroxyhexyl methacrylate, 2-hydroxyoctyl acrylate, 2-hydroxyoctyl methacrylate, diethylene glycol monoacrylate, diethylene glycol monomethacrylate, dipropylene glycol monoacrylate, dipropylene glycol monomethacrylate, 4-hydroxyphenyl acrylate, 4-hydroxyphenyl methacrylate, 2-hydroxyphenyl acrylate, 2-hydroxyphenyl methacrylate, 3-hydroxyphenyl acrylate, 3-hydroxyphenyl methacrylate, cinnamyl alcohol, isopropenylphenol, isopropenylbenzyl alcohol, αα-dimethyl-m-iso-propenylbenzyl alcohols, and 4-hydroxycrotononitrile. It is preferred that these ethylenically unsaturated alcohols have a molecular weight (number average) of from about 69 to about 1500. Preferred ethylenically unsaturated alcohols to be used as component (2) herein are 2-hydroxyethyl methacrylate, 2-hydroxylethyl acrylate, 2-hydroxylpropyl methacrylate, and cinnamyl alcohol.

Suitable hydroxyl group-containing polyethers useful as component (c) in the production of the macromers of the present invention generally have a functionality of at least 1, preferably at least about 2, and more preferably at least about 2.5. The functionality of suitable polyether polyols is less than or equal to 6, preferably less than or equal to 5.5, and most preferably less than or equal to about 5. The suitable polyether polyols may also have functionalities ranging between any combination of these upper and lower values, inclusive. The OH numbers of suitable polyether polyols is at least about 9, preferably at least about 12, and most preferably at least about 20. Polyether polyols typically also have OH numbers of less than or equal to about 60, preferably less than or equal to about 55, and most preferably less than or equal to about 50. The suitable polyether polyols may also have OH numbers ranging between any combination of these upper and lower values, inclusive.

These polyether polyols may also have functionalities ranging from 1 to about 6, preferably from about 2 to about 5.5, and most preferably from about 2.5 to about 5; OH numbers ranging from about 9 to 60, preferably from about 12 to about 55, and most preferably from about 20 to about 50.

Examples of such polyether polyols are known and described in detail in U.S. Pat. No. 7,179,882.

The reaction of the polyisocyanate, the alcohol with reactive unsaturation and the hydroxyl group-containing polyether is optionally carried out in the presence of a catalyst. The presence of a catalyst is not necessary. Virtually any catalyst known to be suitable for promoting the urethane reaction can be used in the present invention. Examples of suitable catalysts that can be used are bismuth-containing catalysts such as COSCAT 83 available from Cosan Chemical Co., tertiary amines, such as triethylamine, dimethylethanol-amine, triethylene diamine (DABCO), bicyclic amidines such as 1,8-diazabicyclo(5.4.0)undec-7-ene (DBU), as well as organometallic catalysts such as stannous octate, dibutyltin dilaurate, dibutyltin mercaptide and the like. Other suitable catalysts are disclosed in U.S. Pat. No. 5,233,009.

In one embodiment of the process for preparing the ethylenically unsaturated macromer of the present invention, the polyisocyanate component is simultaneously reacted with both the alcohol having reactive unsaturation and the hydroxyl group-containing polyether at temperatures of about 25 to about 150° C. for time periods of from about 0.5 to about 5 hours, optionally, in the presence of a urethane catalyst. It is preferred that this reaction is conducted at temperatures of about 40 to about 130° C. for a time of from about 0.5 to about 4 hours.

In another embodiment of the process of the present invention for preparing the ethylenically unsaturated macromer, the polyisocyanate component is first reacted with at least a portion of the alcohol having reactive unsaturation at a temperature of from 40 to 130° C. for a period of 0.5 to 5 hours, preferably, at a temperature of from 50 to 110° C. for a period of from 0.5 to 4. This reaction product of the polyisocyanate component and the alcohol having reactive unsaturation is then further reacted with the hydroxyl group-containing polyether and any remaining portion of the alcohol having reactive unsaturation at temperatures of from about 40 to about 130° C. for time periods of from about 0.5 to about 5 hours, optionally, in the presence of a urethane catalyst. It is preferred that this reaction is at temperatures of about 50 to about 110° C. for a time of from about 0.5 to about 4 hours.

In the process for preparing a pre-formed stabilizer of the present invention, the above-described macromer of the present invention is free-radically polymerized with at least one ethylenically unsaturated monomer in the presence of at least one free-radical polymerization initiator and, optionally, a liquid diluent, and, optionally, a chain transfer agent.

With respect to the pre-formed stabilizers and to the process of making them in accordance with the present invention, it is preferred that the macromer be prepared from (1) a polyisocyanate component that includes a polymeric MDI; (2) that the alcohol having reactive unsaturation be a compound selected from 2-hydroxyethyl methacrylate, 2-hydroxylethyl acrylate, 2-hydroxylpropyl methacrylate, and cinnamyl alcohol; and (3) that the hydroxyl-group-containing polyether include at least one polyether alcohol that is a propylene oxide adduct having an internal ethylene oxide content of from 1 to 50%.

Suitable ethylenically unsaturated monomers (B) for the preformed stabilizers of the invention include: aliphatic conjugated dienes such as butadiene and isoprene; monovinylidene aromatic monomers such as styrene, α-methylstyrene, (t-butyl)styrene, chlorostyrene, cyanostyrene and bromostyrene; α,β-ethylenically unsaturated carboxylic acids and esters thereof such as acrylic acid, methacrylic acid, methyl methacrylate, ethyl acrylate, 2-hydroxyethyl acrylate, butyl actylate, itaconic acid, maleic anhydride and the like; α,β-ethylenically unsaturated nitriles and amides such as acrylonitrile, methacrylonitrile, acrylamide, methacrylamide, N, N-dimethyl acrylamide, N-(dimethylaminomethyl)acrylamide and the like; vinyl esters such as vinyl acetate; vinyl ethers, vinyl ketones, vinyl and vinylidene halides as well as a wide variety of other ethylenically unsaturated materials which are copolymerizable with the aforementioned monomeric adduct or reactive monomer. It is understood that mixtures of two or more of the above-mentioned monomers may also be employed to make the pre-formed stabilizer. Of the above monomers, the monovinylidene aromatic monomers, particularly styrene, and the ethylenically unsaturated nitriles, particularly acrylonitrile are preferred.

When using a mixture of monomers, it is preferred to use a mixture of two monomers. These monomers are typically used in weight ratios of from 80:20 (styrene:acrylonitrile) to 20:80(S:AN), and preferably of from 75:25 (S:AN) to 25:75 (S:AN).

Suitable free-radical polymerization initiators for this aspect of the present invention include: peroxides including both alkyl and aryl hydroperoxides, persulfates, perborates, percarbonates, and azo compounds. Some specific examples include catalysts such as hydrogen peroxide, di(t-butyl)-peroxide, t-butylperoxy diethyl acetate, t-butyl peroctoate, t-butyl peroxy isobutyrate, t-butyl peroxy 3,5,5-trimethyl hexanoate, t-butyl perbenzoate, t-butyl peroxy pivalate, t-amyl peroxy pivalate, t-butyl peroxy-2-ethyl hexanoate, lauroyl peroxide, cumene hydroperoxide, t-butyl hydroperoxide, azobis(isobutyronitrile), and 2,2′-azo bis-(2-methylbutyronitrile).

Suitable catalysts concentrations range from about 0.01 to about 2% by weight, preferably from about 0.05 to 1% by weight, and most preferably 0.05 to 0.3% by weight, based on the total weight of the components (i.e. 100% by weight of the combined weight of the macromer, the ethylenically unsaturated monomer, the free-radical polymerization initiator and, optionally the liquid diluent and/or the chain transfer agent).

Suitable diluents for the pre-formed stabilizers of the present invention include: compounds such as monools (i.e., monohydroxy alcohols), polyols, hydrocarbons, ethers, and mixtures thereof. Suitable mono-ols include all alcohols which contain at least one carbon atom, such as, methanol, ethanol, n-propanol, isopropanol, n-butanol, sec.-butanol, tert-butanol, n-pentanol, 2-pentanol, 3-pentanol, and mixtures thereof. A preferred mono-ol is isopropanol.

Polyols suitable for use as diluents include: poly(oxypropylene) glycols, triols and higher functionality polyols. Such polyols include poly(oxypropylene-oxyethylene) polyols; however, it is preferred that the oxyethylene content comprise less than about 50% of the total and, preferably less than about 20%. The ethylene oxide can be incorporated in any fashion along the polymer chain. Stated another way, the ethylene oxide can be either incorporated in internal blocks, as terminal blocks, or may be randomly distributed along the polymer chain. It is well known in the art that polyols contain varying amounts of non-induced unsaturation. Preferred polyols of the present invention are those which are prepared using DMC catalysis. These polyols have low unsaturation, typically 0.02 meq/g or less as measured using ASTM D2849-69. The extent of unsaturation does not affect in any adverse way the formation of the polymer polyols in accordance with the present invention.

For purposes of the present invention, polyols useful as diluents should have a number average molecular weight of about 500 or greater, the number average used herein being the theoretical, hydroxyl number derived value. The true number average molecular weight may be somewhat less, depending upon the extent to which the true molecular functionality is below the starting or theoretical functionality.

The polyols used as diluents may have hydroxyl numbers which vary over a wide range. In general, the hydroxyl numbers of the polyols employed in the invention can range from about 20 and lower, to about 60 and higher. The hydroxyl number is defined as the number of milligrams of potassium hydroxide required for the complete hydrolysis of the fully phthalated derivative prepared from 1 gram of polyol. The hydroxyl number can also be defined by the equation:

OH=(56.1×1000×f)/m.w.
where:
   OH=hydroxyl number of the polyol;
   functionality, that is, average number of hydroxyl groups per molecule of the polyol; and
   m.w.=molecular weight of the polyol.

The exact polyol employed depends upon the end use of the polyurethane product to be produced. The molecular weight of the hydroxyl number is selected properly to result in flexible or semi-flexible foams or elastomers when the polymer polyol produced from the polyol is converted to a polyurethane. The polyols preferably possess a hydroxyl number of from about 60 to about 250 for semi-flexible foams and from about 20 to about 60 for flexible foams. Such limits are not intended to be restrictive, but are merely illustrative of the large number of possible combinations of the above polyol coreactants.

Other types of polyols suitable for use as a diluent are known and described in U.S. Published Patent Application 20060025558, and specifically in paragraphs [0141] through [0145].

Preferred polyol components to be used as diluents in the present invention typically include: the alkylene oxide adducts of starter materials having 3 or more hydroxyl groups such as glycerin, pentaerythritol, sorbitol, diether of sorbitol, mannitol, diether of mannitol, arabitol, diether of arabitol, sucrose, oligomer of polyvinyl alcohol or glycidol, and mixtures thereof.

When using a mixture of a mono-ol and a polyol as the diluent for the pre-formed stabilizer, the polyol preferably comprises only a minor amount of the diluent and the mono-ol comprises a major amount. In general, the polyol will comprise less than 20 weight percent of the diluent, preferably less than about 15 weight percent, and most preferably less than about 10 weight percent. The amount of the polyol component present in the diluent is below the concentration at which gelling occurs in the pre-formed stabilizer.

Generally, the quantity of diluent is >35% by weight, based on 100% by weight of the PFS (pre-formed stabilizer).

One or more chain transfer agents may also be present in the pre-formed stabilizers of the present invention when one or more chain transfer agents is/are used in the process of making the pre-formed stabilizers. Suitable chain transfer agents useful in the present invention include: isopropanol, ethanol, tert-butanol, toluene, ethylbenzene, triethylamine, dodecylmercaptan, octadecyl-mercaptan, carbon tetrachloride, carbon tetrabronnide, chloroform, and methylene chloride. Chain transfer agents are also commonly referred to as molecular weight regulators. These compounds are employed in conventional amounts to control the molecular weight of the copolymerizate.

Suitable processes for preparing pre-formed stabilizers are similar to known methods described in, for example, U.S. Pat. Nos. 4,148,840, 4,242,249, 4,954,561, 4,745,153, 5,494,957, 5,990,185, 6,455,603, 4,327,005, 4,334,049, 4,997,857, 5,196,476, 5,268,418, 5,854,386, 5,990,232, 6,013,731, 5,554,662, 5,594,066, 5,814,699 and 5,854,358. In general, the process of preparing the pre-formed stabilizer is similar to the process of preparing the polymer polyol. The temperature range is not critical and may vary from about 80 to about 150° C. or higher, and preferably from about 90 to about 140° C. The catalyst and temperature should be selected so that the catalyst has a reasonable rate of decomposition with respect to the hold-up time in the reactor for a continuous flow reactor or the feed time for a semi-batch reactor.

Mixing conditions employed in this process are obtained by using a back mixed reactor (e.g., a stirred flask or stirred autoclave). The reactors of this type keep the reaction mixture relatively homogeneous and thereby prevent localized high monomer to macromer ratios such as occur in tubular reactors, where all of the monomer is added at the beginning of the reactor.

The combination of conditions selected for the preparation of the pre-formed stabilizer should not lead to cross-linking or gel formation in the pre-formed stabilizer. Cross-linking and/or gel formation can adversely affect the ultimate performance of the polymer polyol production process and the product polymer polyol. Combinations of too low a diluent concentration, too high a precursor and/or monomer concentration, too high a catalyst concentration, too long of a reaction time, and too much unsaturation in the precursor can result in an ineffective preformed stabilizer.

Particularly preferred processes for preparing preformed stabilizers are described in, for example, U.S. Pat. No. 5,196,476 and U.S. Pat. No. 6,013,731. Suitable diluents and relative concentrations, ethylenically unsaturated monomers and relative concentrations, free-radical initiators and relative concentrations, and process conditions for the production of preformed stabilizers are also disclosed in U.S. Pat. No. 5,196,476 and U.S. Pat. No. 6,013,731.

The polymer polyols (i.e. stable dispersions) of the present invention are composed of the free-radical polymerization product of a base polyol, the pre-formed stabilizer of the present invention, and one or more ethylenically unsaturated monomers in the presence of at least one free-radical initiator, and optionally, a chain transfer agent. The polymer polyols of the present invention are produced by free-radical polymerization of a base polyol, the pre-formed stabilizer of the present invention, and one or more ethylenically unsaturated monomers in the presence of at least one free-radical initiator, and optionally, a chain transfer agent. The resultant polymer polyols exhibit high solids contents, i.e., from 30 to 60% by weight, based on the total weight of the resultant polymer polyol. It is preferred that the solids content of the polymer polyols ranges from 35 to 55% by weight. These polymer polyols also exhibit low viscosities, i.e. <10,000 mPa·s and possess good filterability.

Suitable base polyols for the production of the polymer polyols of the present invention include polyether polyols. Suitable polyether polyols include those having a functionality of preferably at least about 2, and more preferably at least about 3. The functionality of suitable polyether polyols is less than or equal to about 6, preferably less than or equal to about 5.5, and most preferably less than or equal to about 5. The suitable polyether polyols may also have functionalities ranging between any combination of these upper and lower values, inclusive. The OH numbers of suitable polyether polyols is at least about 20, preferably at least about 25, and most preferably at least about 30. Polyether polyols typically also have OH numbers of less than or equal to about 500, preferably less than or equal to about 400, and most preferably less than or equal to about 250. Suitable polyether polyols may also have OH numbers ranging between any combination of these upper and lower values, inclusive. The equivalent weight of suitable polyether polyols is typically greater than about 100, preferably at least about 300 and most preferably at least about 500. The equivalent weight of suitable polyether polyols is typically less than about 3,000, preferably less than about 2500 and most preferably less than about 2000. Suitable polyether polyols may also have (number average) molecular weights ranging between any combination of these upper and lower values, inclusive.

Examples of compounds to be used herein as polyether polyols are known and described in U.S. Published Patent Application 20060025558, and specifically in paragraphs [0158] through [0162].

Suitable pre-formed stabilizers for this aspect of the present invention include those described above.

The ethylenically unsaturated monomers suitable for producing the polymer polyols of the present invention include those ethylenically unsaturated monomers described above with respect to the preparation of the pre-formed stabilizer. Other suitable monomers include: aliphatic conjugated dienes such as butadiene and isoprene; monovinylidene aromatic monomers such as styrene, α-methyl-styrene, (t-butyl)styrene, chlorostyrene, cyanostyrene and bromostyrene; α,β-ethylenically unsaturated carboxylic acids and esters thereof such as acrylic acid, methacrylic acid, methyl methacrylate, ethyl acrylate, 2-hydroxyethyl acrylate, butyl actylate, itaconic acid, maleic anhydride and the like; α,β-ethylenically unsaturated nitriles and amides such as acrylonitrile, methacrylonitrile, acrylamide, methacrylamide. N,N-dimethyl acrylamide, N-(dimethylaminomethyl)acrylamide and the like; vinyl esters such as vinyl acetate; vinyl ethers, vinyl ketones, vinyl and vinylidene halides as well as a wide variety of other ethylenically unsaturated materials which are copolymerizable with the aforementioned monomeric adduct or reactive monomer. It is understood that mixtures of two or more of the aforementioned monomers may also be employed in making the polymer polyol. Of the above monomers, the monovinylidene aromatic monomers, particularly styrene, and the ethylenically unsaturated nitriles, particularly acrylonitrile are preferred. In accordance with this aspect of the present invention, it is preferred that these ethylenically unsaturated monomers include styrene and its derivatives, acrylonitrile, methyl acrylate, methyl methacrylate, vinylidene chloride, with styrene and acrylonitrile being particularly preferred monomers.

It is preferred that styrene and acrylonitrile be used in amounts such that the weight ratio of styrene to acrylonitrile (SAN) is from about 80:20 to 20:80, more preferably from about 75:25 to 25:75. These ratios are suitable for polymer polyols and the processes of preparing them, regardless of whether they comprise the ethylenically unsaturated macromers or the pre-formed stabilizers of the present invention.

Overall, the quantity of ethylenically unsaturated monomer(s) present in the polymer polyols of the present invention is at least about 30% by weight, based on 100% by weight of the polymer polyol. It is preferred that the solids content is from about 30 to about 60% by weight, more preferably from about 35 to less than 55% by weight, and most preferably from about 40 to about 50% by weight. Overall, the quantity of ethylenically unsaturated monomer(s) present in the polymer polyols of the present invention is at least about 30% by weight, based on 100% by weight of the polymer polyol. It is preferred that the solids content be from about 30 to about 60% by weight.

Suitable free-radical initiators include those previously described for the preparation of the pre-formed stabilizers. Among the useful initiators are those catalysts having a satisfactory half-life within the temperature ranges used in forming the stabilizer, i.e. the half-life should be about 25% or less of the residence time in the reactor at any given time. Preferred initiators include: acyl peroxides such as didecanoyl peroxide and dilauroyl peroxide, alkyl peroxides such as t-butyl peroxy-2-ethylhexanoate, t-butylperpivalate, t-amyl peroctoate, 2,5-dimethyl-hexane-2,5-di-per-2-ethyl hexoate, t-butyl perneodecanoate, t-butylperbenzoate and 1,1-dimethyl-3-hydroxybutyl peroxy-2-ethylhexanoate, and azo catalysts such as azobis(isobutyro-nitrile), 2,2′-azo bis-(2-methoxylbutyronitrile), and mixtures thereof. Most preferred are the acyl peroxides described above and the azo catalysts. A particularly preferred initiator comprises azobis(isobutyronitrile).

The quantity of initiator used is not critical and can be varied within wide limits. In general, the amount of initiator ranges from about 0.01 to 2% by weight, based on 100% by weight of the final polymer polyol. Increases in catalyst concentration result in increases in monomer conversion up to a certain point, but past this, further increases do not result in substantial increases in conversion. The particular catalyst concentration selected will usually be an optimum value, taking all factors into consideration including costs.

Suitable chain transfer agents for use in the practice of the present invention include: isopropanol, ethanol, tert-butanol, toluene, ethylbenzene, triethylamine, dodecylmercaptan, octadecylmercaptan, carbon tetrachloride, carbon tetrabromide, chloroform, and methylene chloride. Chain transfer agents are also commonly referred to as molecular weight regulators. These compounds are employed in conventional amounts to control the molecular weight of the copolymerizate.

Polymer polyols made with the pre-formed stabilizers of the present invention may be prepared by any of the known processes. Examples of such known processes can be found in U.S. Pat. Nos. 4,148,840, 4,242,249, 4,954,561, 4,745,153, 5,494,957, 5,990,185, 6,455,603, 4,327,005, 4,334,049, 4,997,857, 5,196,476, 5,268,418, 5,854,386, 5,990,232, 6,013,731, 5,554,662, 5,594,066, 5,814,699 and 5,854,358. In each of these known processes, a low monomer to polyol ratio is maintained throughout the reaction mixture during the process. This is achieved by employing conditions that provide rapid conversion of monomer to polymer. In practice, a low monomer to polyol ratio is maintained, in the case of semi-batch and continuous operation, by control of the temperature and mixing conditions and, in the case of semi-batch operation, also by slowly adding the monomers to the polyol.

The various components of the polymer polyols of the present invention include the free-radical polymerization product of (I) a base polyol, (II) the ethylenically unsaturated macromer disclosed herein, and (III) at least one ethylenically unsaturated monomer, formed in the presence of (IV) at least one free-radical polymerization initiator, and (V) a chain transfer agent. The components described above with respect to the polymer polyols taught to be useful for the production of the preformed stabilizers of the invention are also suitable for producing the polymer polyols of the present invention. Of course, these polymer polyols use the ethylenically unsaturated macromers described above as reactants in the preformed stabilizers and in the process of preparing the pre-formed stabilizers, to form the polymer polyols instead of the pre-formed stabilizers. The remaining components, their relative amounts and/or ratios are as described above, unless otherwise stated.

These polymer polyols composed of one or more ethylenically unsaturated macromers which correspond to those described above for the pre-formed stabilizers, are prepared by utilizing processes known to those skilled in the art.

In a particularly preferred embodiment of the polymer polyols of the present invention, the ethylenically unsaturated macromer(s) as described are used as ethylenically unsaturated macromers in the production of the polymer polyols of the present invention.

The temperature range is not critical, and may vary from about 80° C. to about 150° C. or, perhaps greater, the preferred range being from 90 to 130° C. As has been noted herein, the catalyst and temperature should be selected so that the catalyst has a reasonable rate of decomposition with respect to the hold-up time in the reactor for a continuous flow reactor or the feed time for a semi-batch reactor.

The mixing conditions used in the production of the polymer polyols of the present invention are those obtained using a back-mixer (e.g., a stirred flask or stirred autoclave). Reactors of this type keep the reaction mixture relatively homogeneous and thereby prevent localized high monomer to polyol ratios such as occur in certain tubular reactors, e.g., in the first stages of “Marco” reactors when such reactors are operated with all of the monomer being added to the first stage.

The processes described in U.S. Pat. Nos. 5,196,476 and 6,013,731 are preferred because they allow preparation of polymer polyols with a wide range of monomer compositions, polymer contents and polymer polyols that could not be otherwise prepared with the necessary stability.

The polymer polyols of the present invention are dispersions in which the polymer particles (the same being either individual particles or agglomerates of individual particles) are relatively small in size and, in the preferred embodiment, are all essentially less than about one to three microns. However, when high contents of styrene are used, the particles will tend to be larger; but the resulting polymer polyols are particularly useful when the end use application requires as little scorch as possible. In the preferred embodiment, essentially all of the product (i.e., about 99% or more) will pass through the filter employed in the filtration hindrance (filterability) test that will be described in conjunction with the Examples. This insures that the polymer polyol products can be successfully processed in all types of the relatively sophisticated machine systems now in use for large volume production of polyurethane products, including those employing impingement-type mixing which necessitate the use of filters that cannot tolerate any significant amount of relatively large particles. Less rigorous applications are satisfied when about 50% of the product passes through the filter. Some applications may also find useful products in which only about 20% or even less passes through the filter. Accordingly, the polymer polyols of the present invention desirably contemplate the products in which as little as 20% of the polymer particles pass through the filter, preferably at least 50%, and most preferably, essentially all of the polymer particles pass through the filter.

In accordance with the present invention, the stabilizer is present in an amount sufficient to insure that satisfactory stabilization will result in the desired filtration hindrance, centrifugible solids level and viscosity. In this regard, the quantity of pre-formed stabilizer generally ranges from about 4 to about 15% (preferably from about 5 to about 10%) by weight, based on the total feed. As one skilled in the art knows and understands, various factors including the free-radical initiator, the solids content, the weight ratio of S:AN, and process conditions will affect the optimum quantity of pre-formed stabilizer.

The polymer polyols of the present invention are particularly useful for the production of polyurethanes, preferably polyurethane foams. Suitable polymer polyols for producing these polyurethanes may be either those prepared directly from ethylenically unsaturated macromers, or those prepared from pre-formed stabilizers which are based on ethylenically unsaturated macromers. These polyurethanes are produced by reacting a polyisocyanate or a prepolymer thereof, with an isocyanate-reactive component that includes the polymer polyols of the present invention in accordance with techniques known to those skilled in the art.

As used herein, the phrase “polyol feed” refers to the amount of base polyol feed present in the polymer polyol or present in the process of preparing the polymer polyol.

As used herein, the phrase “total feed” refers to the sum of all quantities of components present in each of the various products (i.e., preformed stabilizers, polymer polyols, etc.) and/or present in the process of preparing each of the various products.

As used herein, unless otherwise expressly specified, all of the numerical ranges, amounts, values and percentages such as those for amounts of materials, times and temperatures of reaction, ratios of amounts, values for molecular weight, and others in the following portion of the specification may be read as if prefaced by the word “about” even though the term “about” may not expressly appear with the value, amount or range.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all parts and percentages are parts by weight and percentages by weight, respectively.

### Examples

The following components were used in the working examples.
Polyol A: A propylene oxide adduct of sorbitol containing a 16% ethylene oxide cap and having a hydroxyl number of 28 which is commercially available under the name Multranol E-644 from Bayer MaterialScience LLC.
Polyol B: A propylene oxide adduct of glycerin containing a 15% ethylene oxide cap and having a hydroxyl number of 28 which is commercially available under the name Multranol 3901 from Bayer MaterialScience LLC.
Monol A: A propylene oxide adduct of n-butanol containing 6% internal ethylene oxide and having a hydroxyl number of 18 prepared according to Example B in U.S. Pat. No. 6,821,308.
Base Polyol A: A propylene oxide adduct of glycerin containing a 20% ethylene oxide cap, having a hydroxyl number of 36 and a viscosity of 833 mPa·s at 25° C. which is commercially available under the name Hyperlite Polyol E-824 from Bayer MaterialScience LLC.
Isocvanate A: Diphenylmethane 4,4′-diisocyanate (MDI) having an NCO content of about 33.6% which is commercially available under the name Mondur ML from Bayer MaterialScience LLC.
Isocyanate B: A polymeric MDI having a % NCO of about 32.0, a functionality greater than 2 which is commercially available under the name Mondur MR-L from Bayer MaterialScience LLC.
Isocyanate C: A polymeric MDI having a % NCO of about 30.9 and a functionality greater than 2 which is commercially available under the name Mondur 489 from Bayer MaterialScience LLC.
HEMA: 2-hydroxyethyl methacrylate, an ethylenically unsaturated alcohol that is commercially available from Sigma-Aldrich.
HPMA: 2-hydroxypropyl methacrylate, an ethylenically unsaturated alcohol that is commercially available from Sigma-Aldrich.
CTA: Isopropanol, a chain transfer agent
SAN: styrene:acrylonitrile monomer mixture
TMI: Isopropenyl dimethyl benzyl isocyanate (an unsaturated aliphatic isocyanate) sold as TMI® by Cytec Industries
TBPEH: tert-butylperoxy-2-ethylhexanoate, commercially available as Trigonox 21S from AkzoNobel
AIBN: 2,2′-azobisisobutyronitrile, a free radical polymerization initiator commercially available as VAZO 64 from E.I. DuPont de Nemours and Co.
Viscosity: Viscosities were measured by using an Anton-Paar Stabinger viscosmeter (mPa·s at 25° C.)

### Filterability Test:

Filterability was determined by diluting one part by weight sample (e.g., 200 grams) of polymer polyol with two parts by weight anhydrous isopropanol (e.g., 400 grams) to remove any viscosity-imposed limitations and using a fixed quantity of material in relation to a fixed cross-sectional area of screen (e.g., 1⅛ in. diameter), such that all of the polymer polyol and isopropanol solutions passed by gravity through a 150-mesh or 700-mesh screen. The 150-mesh screen had a square mesh with average mesh opening of 105 microns and was a “Standard Tyler” 150 square-mesh screen. The 700-mesh screen was made with a Dutch twill weave. The actual screen used had a nominal opening of 30 microns. The amount of sample which passed through the screen within 600 seconds is reported in percent with a value of 100 percent indicating that over 99 weight percent passed through the screen.

### Macromer Preparation

### Macromer A:

Macromer A was prepared by heating a mixture of Polyol A (100 parts), TMI (2 parts), Isocyanate A (1.5 parts) and 100 ppm of bismuth neodecanoate catalyst at 75° C. for 4 hours.

### Macromer B:

Macromer B was prepared in three steps. In the first step, a mixture of Isocyanate A (50 g), Isocyanate B (450 g), HEMA (92 g), and 1,4-benzoquinone (BQ) (0.4 g) was stirred for 2 hours at 60° C. to obtain a liquid modified isocyanate with a % NCO of 23.3. In the second step, the modified isocyanate (94 g) was added to 3500 g of Polyol B, bismuth neodecanoate (0.5 g) and 1,4-benzoquinone (1.1 g) and the resultant mixture was heated at 70° C. for 3 hours. In the third step, 4-methoxyphenol (1.0 g) was added and the product was cooled to give a clear liquid with a viscosity of 8228 mPa·s at 25° C.

### Macromer C:

A mixture of Monol A (2575 g), HPMA (15.5 g), BQ (1 g), and bismuth neodecanoate (0.5 g) was heated with stirring under nitrogen in a 12 L flask. Isocyanate C was then added at a rate to keep the reaction temperature <80° C. The reaction mixture was then stirred at 75° C. for 3 hours. 4-Methoxyphenol (1.0 g) was added and the product was cooled to give a clear liquid with a viscosity of 3376 mPa·s at 25° C.

### General Pre-Formed Stabilizer (PFS) Process:

The general process for the preparation of pre-formed stabilizers A, B and C from Macromers A, B, and C, respectively, was as follows. Each of the pre-formed stabilizers was prepared in a two-stage reaction system composed of a continuously-stirred tank reactor (CSTR) fitted with an impeller and 4 baffles (first-stage) and a plug-flow reactor (second stage). The residence time in each reactor was about 60 minutes. The reactants were pumped continuously to the reactor from feed tanks through an in-line static mixer and then through a feed tube into the reactor, which was well mixed. The temperature of the reaction mixture was controlled at 120° C. The product from the second-stage reactor overflowed continuously through a pressure regulator designed to control the pressure in each stage at 65 psig. The pre-formed stabilizer then passed through a cooler and into a collection vessel. The formulation used for each pre-formed stabilizer is listed in Table 1 in which the component concentrations are based on the total feed.

TABLE 1
Preformed Stabilizer Composition:

| | PFS A | PFS B | PFS C |
|---|---|---|---|
| Chain Transfer Agent | Isopropanol | Isopropanol | Isopropanol |
| Chain Transfer Agent | 30-80 | 30-80 | 30-80 |
| in feed, wt. % | | | |
| Macromer | A | B | C |
| Macromer in feed, | 10-40 | 10-40 | 10-40 |
| wt. % | | | |
| Monomer (50/50 | 10-30 | 10-30 | 10-30 |
| S/AN in feed, wt. % | | | |
| TBPEH | 0.1-2 | 0.1-2 | 0.1-2 |
| Concentration, wt. % | | | |

### General Polymer Polyol (PMPO) Formulations:

This series of examples relates to the preparation of polymer polyols made from pre-formed stabilizers A, B and C, respectively. Each of the polymer polyols was prepared in a two-stage reaction system comprising a continuously-stirred tank reactor (CSTR) fitted with an impeller and 4 baffles (first-stage) and a plug-flow reactor (second stage). The residence time in each reactor was about 60 minutes. The reactants were pumped continuously from feed tanks through an in-line static mixer and then through a feed tube into the reactor, which was well mixed. The temperature of the reaction mixture was controlled at 115° C. The product from the second-stage reactor overflowed continuously through a pressure regulator designed to control the pressure in each stage at 45 psig. The polymer polyol then passed through a cooler and into a collection vessel. The crude product was vacuum stripped to remove volatiles. The wt. % total polymer in the product was calculated from the concentrations of monomers measured in the crude polymer polyol before stripping. The materials used and the properties of the product polymer polyols are reported in Table 2.

TABLE 2

| Example | 1* | 1a* | 2 | 3 |
|---|---|---|---|---|
| Preparation Conditions: | | | | |
| Initiator (AIBN) in feed, wt % | 0.3 | | 0.3 | 0.3 |
| Base polyol | A | | A | A |
| Base polyol in feed, wt % | 51.5 | | 51.3 | 51.2 |
| PFS | A | | B | C |
| Macromer | A | | B | C |
| Macromer in feed, wt % | 1.9 | | 2.0 | 2.0 |
| Chain Transfer Agent in feed, wt % | 4.8 | | 5.0 | 5.0 |
| Monomers (60/40 SAN) in feed, wt % | 40.3 | | 40.1 | 40.1 |
| 150-Mesh filtration, % | 100 | | 100 | 100 |
| 700-Mesh filtration, % | 100 | | 100 | 100 |
| Product Properties: | | | | |
| Total polymer (stripped product), wt % | 43.0 | 43.6¹ | 43.6 | 43.0 |
| Viscosity, mPa · s (25° C.) | 5697 | 5927¹ | 5776 | 5407 |

*Comparative Example
¹It is commonly known that an increase in wt % polymer leads to an increase in viscosity. Using formulas common in PMPO technology (i.e. U.S. Pat. No. 6,455,603 and U.S. Pat. No. 7,179,882), the viscosity for comparative Example 1 at 43.6% polymer would be expected to be about 230 mPa · s units higher, or 5927 mPa · s.

As can be seen in Examples 2 and 3, the polymer polyols produced in accordance with the present invention had a lower viscosity than the comparative polymer polyol having the same total polymer wt. %.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A high functionality macromer which comprises the reaction product of:
(a) a polyisocyanate having an NCO group content of about from about 10% to about 33% having a functionality greater than 2,
(b) at least one alcohol with reactive unsaturation,
and
(c) a hydroxyl group-containing polyether having an OH number of from 9 to 60 and a functionality of from 1 to 6,
optionally, in the presence of
(d) a catalyst.

2. The macromer of claim 1 in which (a) is selected from the group consisting of aliphatic isocyanates, aromatic isocyanates, and mixtures thereof.

3. The macromer of claim 1 in which (b) is selected from the group consisting of hydroxyalkyl acrylates, hydroxyalkyl methacrylates, hydroxyaryl acrylates, hydroxyaryl methacrylates, aromatic-substituted ethylenically unsaturated monols, isopropenylphenyl monols, hydroxyl nitriles, and mixtures thereof.

4. The macromer of claim 1 in which (b) comprises 2-hydroxyethyl methacrylate.

5. The macromer of claim 1 in which (a) and (b) are reacted before being reacted with (c).

6. A process for the preparation of a high functionality macromer, comprising:
(I) reacting
(a) a polyisocyanate having an NCO group content of about 10 to about 33% having a functionality greater than 2,
(b) at least one alcohol with reactive unsaturation and
(c) a hydroxyl group-containing polyether having an OH number of from 9 to 60 and a functionality of from 1 to 6,
optionally, in the presence of
(d) a catalyst.

7. The process of claim 6 in comprising reacting (a) and (b) to form a modified polyisocyanate that is subsequently reacted with (c).

8. A preformed stabilizer comprising the free-radical polymerization product of:
(A) macromer of claim 1,
with
(B) at least one ethylenically unsaturated monomer,
formed in the presence of
(C) at least one free-radical polymerization initiator,
and, optionally,
(D) a liquid diluent,
and, optionally,
(E) a chain transfer agent.

9. The preformed stabilizer of claim 8 in which (A) comprises the reaction product of:
(a) a polyisocyanate having an NCO group content of from about 10 to about 33%
with
(b) an alcohol selected from the group consisting of hydroxyalkyl acrylates, hydroxyalkyl methacrylates, hydroxyaryl acrylates, hydroxyaryl methacrylates, aromatic-substituted ethylenically unsaturated monols, isopropenyiphenyl monols, hydroxyl nitriles and mixtures thereof;
and
(c) a hydroxyl group-containing polyether having a functionality of from about 1 to about 6, an OH number of from about 9 to about 60 and a molecular weight of from about 2,000 to about 12,000.

10. A process for the preparation of a preformed stabilizer comprising:
(I) free-radically polymerizing:
(A) ethylenically unsaturated macromer of claim 1,
with
(B) at least one ethylenically unsaturated monomer,
in the presence of
(C) at least one free-radical polymerization initiator,
and, optionally,
(D) a liquid diluent,
and, optionally,
(E) a chain transfer agent.

11. A polymer polyol comprising the reaction product of:
(I) a base polyol having a hydroxyl number of from about 20 to about 500, a functionality of about 2 to about 6, and an equivalent weight of from about 100 to about 3,000,
(II) the preformed stabilizer of claim 9,
and
(III) at least one ethylenically unsaturated monomer,
in the presence of
(IV) at least one free-radical polymerization initiator,
and, optionally,
(V) a chain transfer agent.

12. The polymer polyol of claim 11 in which (IV) is selected from the group consisting of acyl peroxides, alkyl peroxides, azo compounds and mixtures thereof.

13. A process for the production of a polymer polyol comprising.
(1) free-radically polymerizing:
(I) a base polyol having a hydroxyl number of from about 20 to about 500, a functionality of from about 2 to about 6,
(II) the preformed stabilizer of claim 9,
and
(III) at least one ethylenically unsaturated monomer,
in the presence of
(IV) at least one free-radical polymerization initiator,
and, optionally,
(V) a chain transfer agent.

14. The process of claim 13 in which (IV) is selected from the group consisting of acyl peroxides, alkyl peroxides, azo compounds and mixtures thereof.

15. A polymer polyol comprising the reaction product of:
(I) a base polyol having a hydroxyl number of from about 20 to about 500, a functionality of from about 2 to about 6,
(II) the macromer of claim 1,
and
(III) at least one ethylenically unsaturated monomer,
in the presence of:
(IV) at least one free-radical polymerization initiator,
and, optionally,
(V) a chain transfer agent.

16. A process for the production of a polymer polyol comprising:
(1) free-radically polymerizing:
(I) a base polyol having a hydroxyl number of from about 20 to about 500, a functionality of from about 2 to about 6,
(II) the macromer of claim 1,
and
(III) at least one ethylenically unsaturated monomer,
in the presence of:
(IV) at least one free-radical polymerization initiator,
and, optionally,
(V) a chain transfer agent.

17. A process of for the production of a polyurethane comprising reacting (1) a polyisocyanate with (2) an isocyanate-reactive component comprising the polymer polyol of claim 15.

18. A process for the production of a polyurethane comprising reacting (1) a polyisocyanate with (2) an isocyanate-reactive component comprising the polymer polyol of claim 11.
